(19) United States
(12) Patent Application Publication
(10) Pub. No.: US 2014/0190712 A1
(43) Pub. Date: Jul. 10, 2014

(54) UNIVERSAL BRACKET ADAPTOR ASSEMBLY FOR AGRICULTURAL IMPLEMENTS

(71) Applicant: DAWN EQUIPMENT COMPANY, Sycamore, IL (US)

(72) Inventor: Joseph D. Bassett, Sycamore, IL (US)

(73) Assignee: Dawn Equipment Company, Sycamore, IL (US)

(21) Appl. No.: 13/736,686

(22) Filed: Jan. 8, 2013

(51) Int. Cl. A01B 76/00

(52) U.S. Cl. CPC A01B 76/00
USPC 172/763

(57) ABSTRACT

Universal bracket adaptor assemblies, pressure control units, and methods for using the same are disclosed. A bracket adaptor assembly is disclosed for assisting in coupling any of an assortment of structurally distinct agricultural implements to a towing frame of an agricultural machine. The assembly includes a support bracket with two coupling portions, the first coupling portion being configured to operatively attach to any of the agricultural implements. An adaptor plate is configured to operatively attach to the towing frame. The adaptor plate has numerous attachment interface points configured to couple with the second coupling portion of the support bracket. Coupling the support bracket to a first subset of the attachment interface points of the adaptor plate assists in coupling a first agricultural implement to the towing frame. Coupling the support bracket to a second subset of the attachment interfaces assists in coupling a second agricultural implement to the towing frame.

### TECHNICAL FIELD

The present disclosure relates generally to agricultural apparatuses and implements. More particularly, the present disclosure relates to bracket assemblies for attaching an agricultural implement to agricultural machinery.

### BACKGROUND

The mechanization and automation of farm labor has been achieved primarily through the use of different agricultural implements that are either carried or drawn by agricultural machinery, such as tractors, harvesters and combines of various sizes and designs. Oftentimes, the various implements and other pieces of equipment used with a piece of agricultural machinery are produced by different manufacturers. For instance, many implements intended for use with a particular tractor or line of tractors are produced by manufacturers that are not affiliated with the manufacturer of that tractor/line of tractors. Conversely, various makes and models of tractors may be utilized on a single farm to operate an implement made by an unaffiliated manufacturer. Consequently, a particular type of farm implement, such as a planting row unit that is manufactured by one manufacturer, may not be readily interchangeable with another planting row unit manufactured by another manufacturer for use on the same tractor. In order to accommodate implements made by a variety of manufacturers to a particular tractor or line of tractors, and vice versa, it may be desirable to provide a joint or adaptor for attaching implements from different manufacturers to tractors of various makes and models.

### SUMMARY

One aspect of the present disclosure is directed to an adaptor assembly for enabling a linkage assembly to couple any of a plurality of agricultural implements to a towing frame. The linkage assembly has a linkage bar that is attached to a front bracket, which is coupled to the towing frame. Each of the agricultural implements is at least partially structurally distinct from the other implements. The adaptor assembly includes a support bracket with first and second coupling portions. The first coupling portion is configured to attach to the linkage bar of the linkage assembly. The adaptor assembly also includes an adaptor plate that is configured to attach to the front bracket. The adaptor plate has a plurality of attachment interface points configured to couple with the second coupling portion of the support bracket. Coupling the support bracket to a first subset of the attachment interface points of the adaptor plate enables the linkage assembly to couple a first one of the plurality of agricultural implements to the towing frame. Conversely, coupling the support bracket to a second subset of the attachment interface points of the adaptor plate enables the linkage assembly to couple a second one of the plurality of agricultural implements to the towing frame.

In accordance with another aspect of the disclosure, a pressure control unit is featured for attaching any of a plurality of agricultural implements to a towing frame. Each of the agricultural implements is at least partially structurally distinct from the other implements. The pressure control unit includes a front bracket that is adapted to rigidly attach to the towing frame, and a linkage bar pivotably attached to the front bracket. The linkage bar is adapted to pivotably mount to any of the plurality of agricultural implements. The pressure control unit also includes a pressurized-fluid cylinder with a movable ram, which extends out of the pressurized-fluid cylinder and is coupled to the linkage bar. The pressurized-fluid cylinder forms therein a fluid cavity configured to receive pressurized fluid for moving the ram and thereby pivoting the linkage. An energy storage device, which is adjacent the pressurized-fluid cylinder, defines therein a fluid chamber containing a diaphragm. A first portion of the chamber on one side of the diaphragm is fluidly coupled to the fluid cavity in the pressurized-fluid cylinder, and a second portion of the chamber on the other side of the diaphragm contains pressurized fluid. The pressure control further comprises a support bracket with first and second coupling portions. The first coupling portion of the support bracket is attached to the linkage bar via the pressurized-fluid cylinder and the movable ram. An adaptor plate is attached to the front bracket. The adaptor plate has a plurality of attachment interface points configured to couple with the second coupling portion of the support bracket and thereby attach the adaptor plate to the support bracket. Coupling the support bracket to a first subset of the attachment interface points of the adaptor plate enables the linkage assembly to couple a first one of the plurality of agricultural implements to the towing frame. In contrast, coupling the support bracket to a second subset of the attachment interface points of the adaptor plate enables the linkage assembly to couple a second one of the plurality of agricultural implements to the towing frame.

Another aspect of this disclosure is directed to a universal bracket adaptor assembly for assisting in coupling any of an assortment of structurally distinct agricultural implements to a towing frame of an agricultural machine. The adaptor assembly includes a support bracket with first and second coupling portions. The first coupling portion is configured to operatively attach to any of the agricultural implements. The adaptor assembly also includes an adaptor plate that is configured to operatively attach to the towing frame. The adaptor plate has a plurality of attachment interface points configured to couple with the second coupling portion of the support bracket. Coupling the support bracket to a first subset of the attachment interface points of the adaptor plate assists in coupling a first one of the agricultural implements to the towing frame. Coupling the support bracket to a second subset of the attachment interfaces of the adaptor plate assists in coupling a second one of the agricultural implements to the towing frame.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an agricultural implement attached to the towing frame of an agricultural machine, in part, with a representative universal bracket adaptor assembly in accordance with aspects of the present disclosure.

FIG. 2 is a partially sectioned side-view illustration of the agricultural implement, towing frame and universal bracket adaptor assembly of FIG. 1 showing the linkage assembly that connects the agricultural implement to the towing frame in a level position.

FIG. 3 is a partially sectioned side-view illustration of the agricultural implement, towing frame and universal bracket adaptor assembly of FIG. 1 showing the linkage assembly tilted upwardly to move the agricultural implement to a raised position.

FIG. 4 is a partially sectioned side-view illustration of the agricultural implement, towing frame and universal bracket adaptor assembly of FIG. 1 showing the linkage assembly tilted downwardly to move the agricultural implement to a lowered position.

FIG. 5 is an enlarged perspective-view illustration of the linkage assembly of FIG. 1 with a portion of the linkage assembly being broken away to more clearly show the mounting of a representative down-pressure control unit in accordance with aspects of the present disclosure.

FIGS. 6A and 6B are front-view and side-view illustrations, respectively, of the universal bracket adaptor assembly of FIG. 1 configured to attach an agricultural implement of a first design to the towing frame of an agricultural machine.

FIGS. 7A and 7B are front-view and rear-view illustrations, respectively, of a representative modular plate of the universal bracket adaptor assembly of FIG. 1.

FIGS. 8A and 8B are front-view and side-view illustrations, respectively, of the universal bracket adaptor assembly of FIG. 1 configured to attach an agricultural implement of a second design, distinct from the first design, to the towing frame of the agricultural machine.

FIGS. 9A and 9B are front-view and side-view illustrations, respectively, of the universal bracket adaptor assembly of FIG. 1 configured to attach an agricultural implement of a third design, distinct from the first and second designs, to the towing frame of the agricultural machine.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

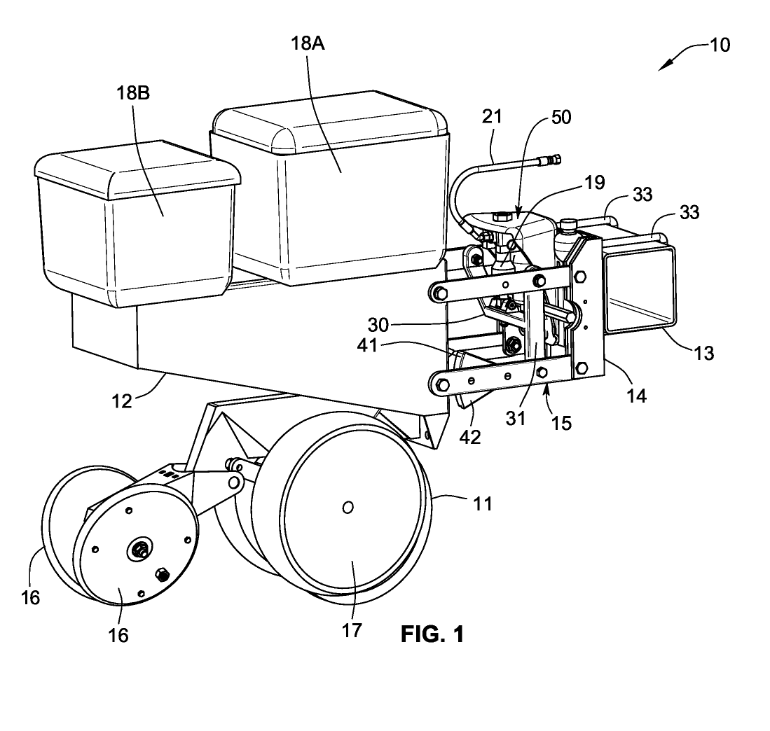

Referring now to the drawings, wherein like reference numerals refer to like features throughout the several views, there is shown in FIG. 1 a representative agricultural row unit, designated generally at 10, that is attached to the towing frame 13 of an agricultural machine (not shown). With regard to the present disclosure, the agricultural machine is non-limiting in nature and therefore may take on any known form, such as a tractor or other tractive machine. In the same vein, the inventive aspects of this disclosure are not per se limited to the illustrated application, and may be utilized with other row units, towing frames and agricultural implements without departing from the scope and spirit of this disclose. Moreover, only selected components of the row unit and towing frame have been shown and will be described in additional detail hereinbelow. Nevertheless, the row unit and towing frame discussed herein can include numerous additional and alternative components. Seeing as these components are well known in the art, they will not be described in further detail. Lastly, the drawings presented herein are not necessarily to scale and are provided purely for descriptive purposes; thus, the specific and relative dimensions shown in the drawings are not to be considered limiting.

In the illustrated embodiment, the agricultural row unit 10 includes an agricultural implement, represented herein by a furrow-opening device (sometimes referred to as a “seeder”) that is designed for planting seed and/or injecting fertilizer into soil. As shown, the furrow-opening device is a V-opener 11 formed by a pair of conventional tilted discs depending from the leading end of a row unit frame 12. It will be understood that other furrow-opening devices may be used without departing from the scope and spirit of the present disclosure. A conventional elongated, hollow towing frame 13, which is typically hitched to a tractor by a draw bar, is rigidly attached to the front frame 14 (also referred to as “front bracket”) of a four-bar linkage assembly 15, for example, via a pair of threaded U-shaped connector rods 33. As shown, the front frame 14 is a contoured plate with a pair of laterally spaced, generally parallel flanges, each of which has an upper linkage bar 15B, 15C and a lower linkage bar 15A, 15D pivotably connected thereto (e.g., via bolts). The four-bar (sometimes referred to as “parallel-bar”) linkage assembly 15 is used in agricultural implements to permit the raising and lowering of tools attached thereto.

As the planting row unit 10 is advanced by a tractor or other tractive mechanism, the V-opener 11 penetrates the soil to form a furrow or seed slot. Other portions of the row unit 10 then deposit seed in the seed slot and fertilizer adjacent to the seed slot, and close the seed slot by distributing loosened soil into the seed slot with a pair of closing wheels 16. A gauge wheel 17 determines the planting depth for the seed and the height of introduction of fertilizer, etc. A pair of bins 18A and 18B mounted on top of the row unit frame 12 carries the fertilizer chemicals and seed which are directed into the soil. The planting row unit 10 is urged downwardly against the soil by its own weight. In addition, a pneumatic cylinder 19 (also referred to herein as “pressurized-fluid cylinder”), which is coupled between the front frame 14 and the linkage assembly 15, in part, via a universal bracket adaptor assembly 50, is selectively operable to urge the row unit 11 downwardly with a controllable force that can be adjusted for different soil conditions. The pneumatic cylinder 19 may also be used to lift the row unit off the ground for transport by a heavier, stronger, fixed-height frame that is also used to transport large quantities of fertilizer for application via multiple row units. The function and operation of the pneumatic cylinder 19 will be developed in further detail hereinbelow.

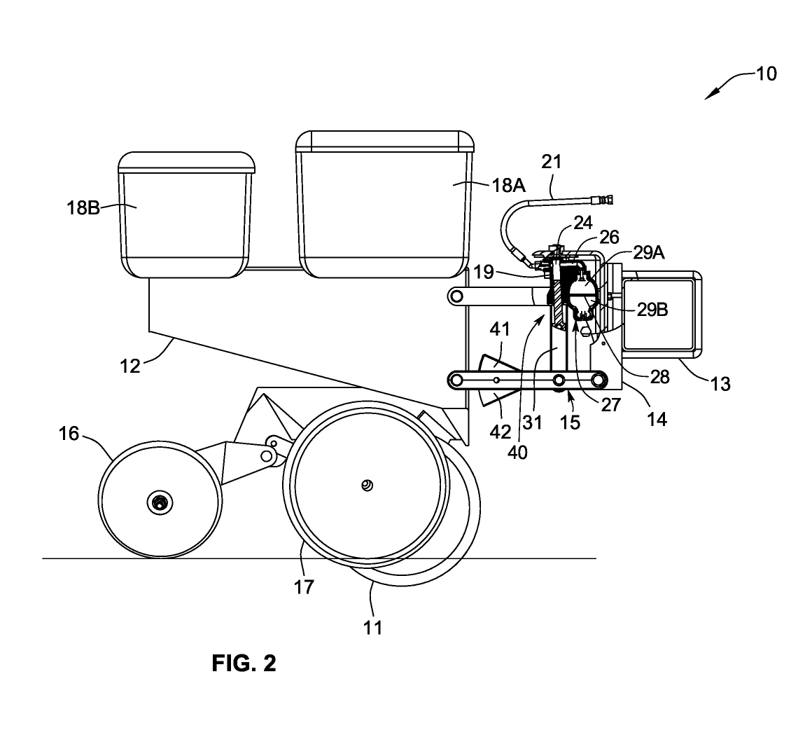

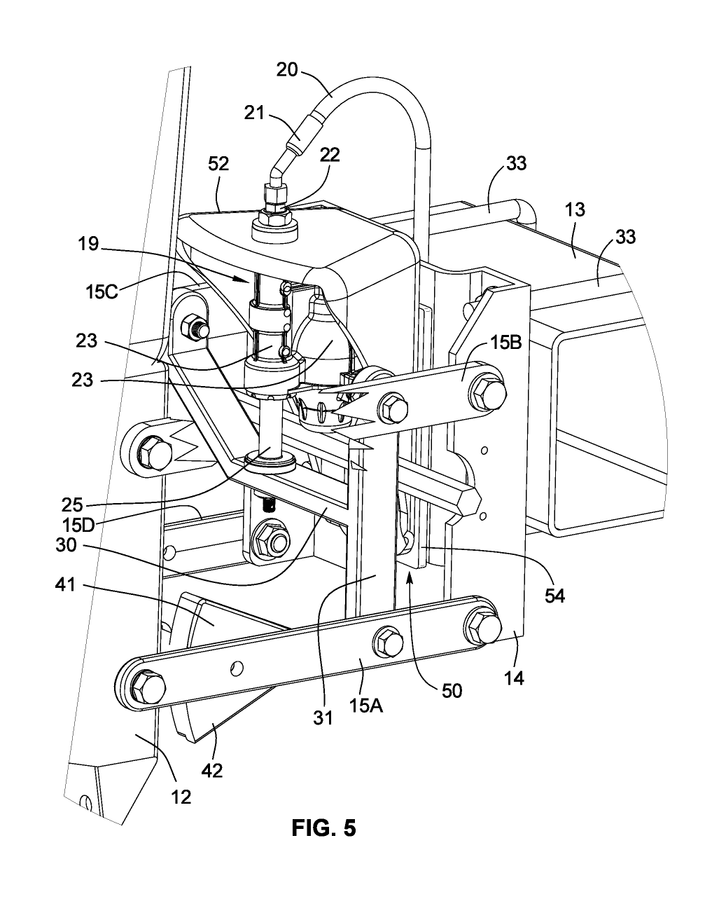

With reference to both FIGS. 1 and 5, pressurized fluid from the tractor or other pressurized fluid source is supplied to the pneumatic cylinder 19 by a hose 20. The hose 20 transmits pressurized fluid through a stem 21 that leads into a complementary port 22 of a housing 23, which forms a cavity 24 (FIG. 2) within the pneumatic cylinder 19. A ram 25 is slidably disposed inside the cavity 24, projecting outwardly from a lower end of the housing 23 of the pneumatic cylinder 19. As seen in FIG. 2, the housing 23 also forms a side port 26 that fluidly couples the cavity 24 with an energy storage device, which is represented herein by a gas-charged accumulator 27. The lower end of the cavity 24 is formed by the top end surface of the ram 25, so that the pressure exerted by the pressurized fluid on the end surface of the ram 25 urges the ram downwardly (as viewed in FIG. 5), with a force determined by the pressure of the pressurized fluid and the area of the exposed end surface of the ram 25. The introduction of pressurized fluid thus urges the ram 25 in an advancing direction (e.g., downwardly in FIG. 5).

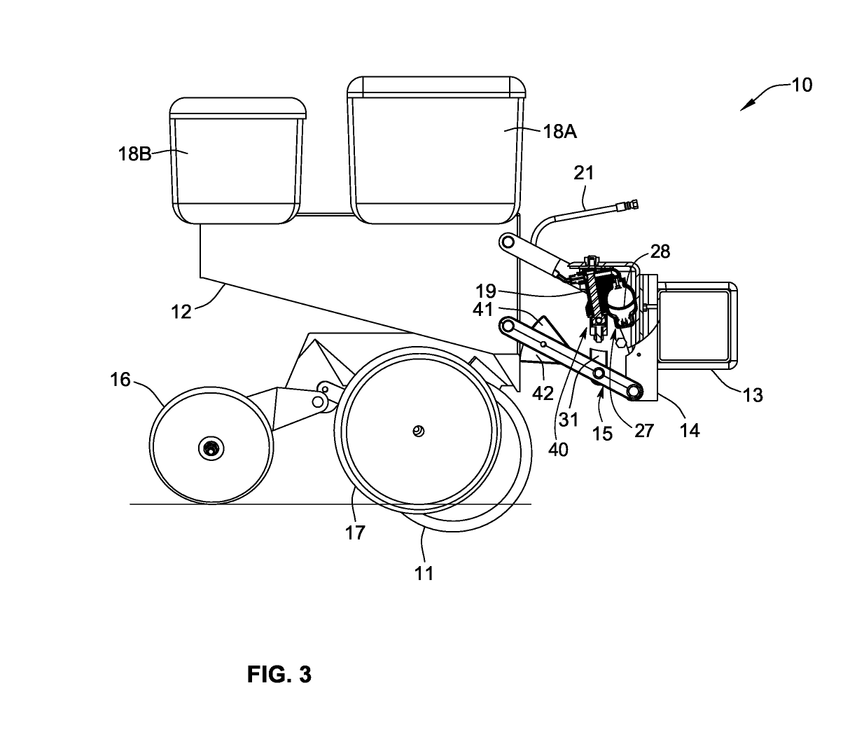

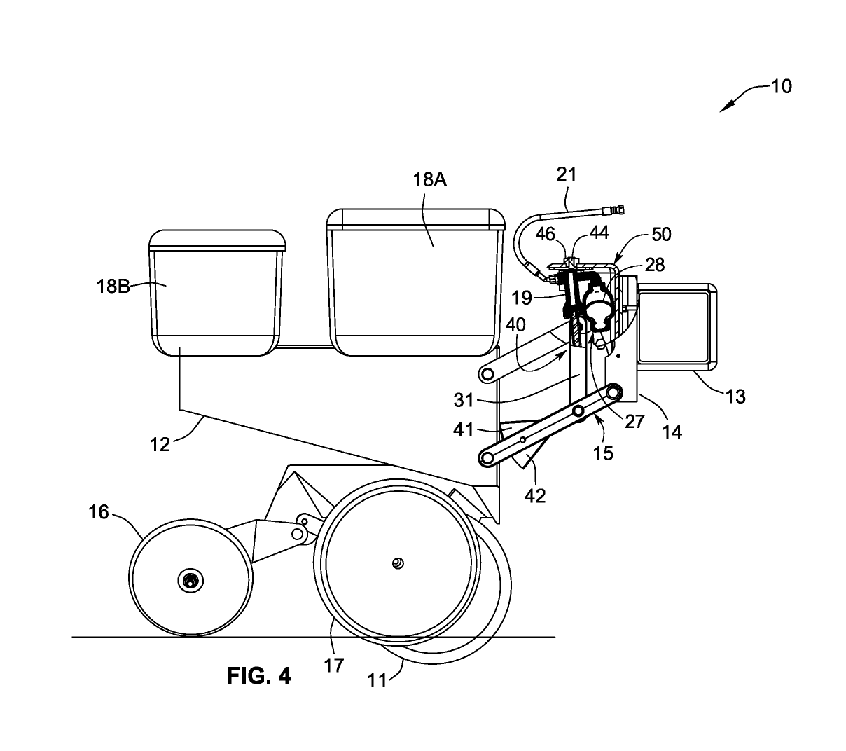

As can be seen most clearly in FIG. 2, the pneumatic cylinder 19 and the accumulator 27 are mounted as a single unit on the front frame 14, with the lower end of the ram 25 connected to a crossbar 30 (FIG. 5) that is joined at one end to a vertical link 31. The upper and lower ends of the link 31 are pivotably attached to upper and lower linkage bars 15A and 15B, respectively, on one side of the four-bar linkage assembly 15. The other end of the crossbar 30 is angled upwardly and pivotably attached to another upper linkage bar 15C on the opposite side of the four-bar linkage assembly 15. With this mounting arrangement, retracting movement of the ram 25 into the cavity 24, as depicted in FIG. 3, tilts the linkage assembly 15 upwardly, thereby raising the row unit 10. Conversely, advancing movement of the ram 25, as depicted in FIG. 4, tilts the linkage assembly 15 downwardly, thereby lowering the row unit 10. In accord with an optional arrangement, the down-pressure control unit 40 can be configured as a double-acting control unit capable of selectively exerting a lifting (upward) force and a lowering (downward) force on the row unit 10. Moreover, although the down-pressure control unit 40 is shown and described as being mounted to the towing frame 13 via the front bracket 14 and the universal bracket adaptor assembly 50, optional configurations can include mounting the down-pressure control unit 40 directly to the towing frame 13 or directly to the row unit frame 12 via the bracket adaptor assembly 50.

The accumulator 27 includes a diaphragm 28 that divides the interior of the accumulator into a pressurized-fluid chamber 29A and a gas-filled chamber 29B, which may be filled, for example, with pressurized nitrogen. FIG. 2 shows the ram 25 in a position where the diaphragm 28 is not deflected in either direction, indicating that the pressures exerted on opposite sides of the diaphragm are substantially equal. In FIG. 3, however, the ram 25 has been retracted into the cavity 24, for example, by upward movement of the row unit, and the diaphragm 28 is deflected downwardly by the pressurized fluid forced into the accumulator 27 by the retracting movement of the ram 25. By comparison, in FIG. 4, the ram 25 has been moved to its most advanced position, and the diaphragm 28 is deflected upwardly by the air pressure as pressurized fluid flows from the accumulator into the cavity 24. Use of this compact pressurized down-force unit with an integral accumulator on each row unit can provide the advantages of quick response and remote adjustability of a pressurized down-force control system. If an obstruction requires quick movement, oil can flow quickly and freely between the force cylinder and the adjacent accumulator.

In FIG. 3, the ram 25 has been withdrawn to its most retracted position, which can occur, for example, when the row unit 10 encounters a rock or other obstruction. When the ram 25 is in this retracted position, the row unit is in its uppermost position. As can be seen in FIG. 3, retracting movement of the ram 25 is limited by engagement of one or more stops 42, which are mounted on the lower linkage arms of the four-bar linkage 15, with the row unit frame 12.

As can be seen in FIG. 4, advancing movement of the ram 25 is limited by engagement of one or more stops 41, which are mounted on the lower linkage arms of the four-bar linkage 15, with the row unit frame 12. This prevents any further advancement of the ram 25. Advancing movement of the ram 25 expands the size of the cavity 24 (see FIG. 4), which causes the diaphragm 28 in the accumulator 27 to deflect to the position illustrated in FIG. 4 and reduce the amount of pressurized fluid in the accumulator 27. When the ram 25 is in this advanced position, the row unit 10 is in its lowermost position.

As can be seen in FIGS. 2-4, the single unitary housing 23 forms both the cavity that contains the accumulator 27 and the cavity 24 of the pneumatic cylinder 19, as well as the fluid passageway 24 that connects the cavity 24 of the pneumatic cylinder 19 to the cavity of the accumulator 27. By integrating the pneumatic cylinder 19 and the accumulator 27 into a single housing, there is no relative motion possible between the cylinder 19 and the accumulator 27, with minimal possibility for fluid passageways to act like orifices. The cylinder 19 and the accumulator 27 remain in fixed positions relative to each other regardless of the movements of the planter row unit via the linkage assembly 15. In this way the upward motion of the ram 25 that occurs when the planter row unit rolls over an obstruction is directly converted into compression of the gas in the accumulator 27 without restriction. It also allows the accumulator 27, which is by definition an energy storage device, to be mounted in a fully enclosed and safe housing. The accumulator 27 can be securely mounted to avoid puncture or rapid discharge (if it comes loose), or damage from hitting another part of the implement or a foreign object. The integrated cylinder and accumulator is also a convenient single package for installation and replacement and minimizes the number of hoses and adapters (potential leakage points). Additional information about the down-pressure control unit 40 illustrated in FIGS. 1-5 can be found, for example, in commonly assigned U.S. patent application Ser. No. 12/882,627 (corresponding to U.S. Patent Appl. Pub. No. 2012/0060730 A1), to Joseph D. Bassett, which is incorporated herein by reference in its entirety and for all purposes. It should be readily understood that the aspects of the present disclosure can be practiced with many types of devices for lifting/lowering the row unit 10, including other types of hydraulic and pneumatic devices, as well as electro-mechanical devices, for example.

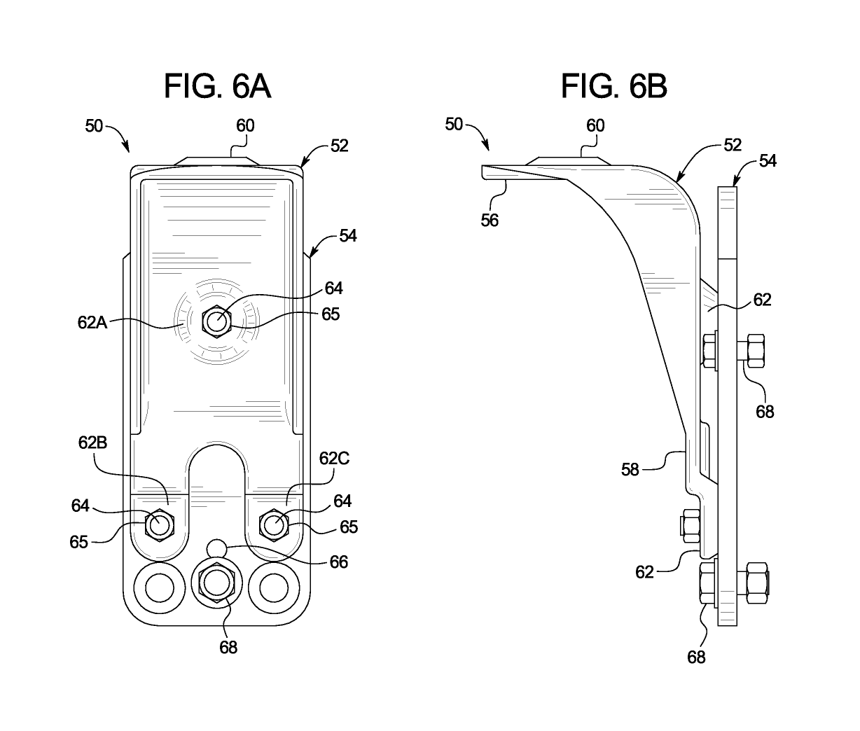

FIGS. 6A and 6B illustrate a universal bracket adaptor assembly, designated generally as 50, for enabling a linkage assembly, such as the four-bar linkage assembly 15 of FIGS. 1-5, to operatively couple any of a number of structurally distinct agricultural implements to a towing frame of an agricultural machine. In a specific implementation, integration of the adaptor assembly 50 into a linkage assembly allows a down-pressure control unit to operate with planting row units that are manufactured by a variety of different manufacturers. By way of non-limiting example, the universal bracket adaptor assembly 50 can enable the down-pressure control unit 40 to operatively couple with a number of different furrow-opening devices, each of which is fabricated by a different equipment manufacturer. The adaptor assembly 50 can therefore eliminate the need for multiple brackets to enable the linkage assembly 15 and down-pressure control unit 40 to operatively couple with furrow-opening devices that are fabricated by different equipment manufacturers.

The adaptor assembly 50 comprises two primary components: a support bracket 52 and an adaptor plate 54. In the illustrated example, the support bracket 52 is a single-piece unitary structure. For some preferred embodiments, the support bracket 52 is a cast or stamped piece of metal, such as aluminum or steel. The support bracket 52 may optionally be fabricated from a rigid plastic, such as polyvinyl chloride (PVC), polypropylene, etc., having sufficient strength and resilience for the intended application of the adaptor assembly 50. Alternatively, the support bracket 52 can consist of an assemblage of interconnected subcomponents. The support bracket 52 of FIGS. 6A and 6B is arcuate with a J-shaped or scoop-shaped structure with a tail 56 that projects generally orthogonally from a stem 58.

The support bracket 52 has two coupling portions: a first coupling portion 60 that is configured to attach to one or more linkage bars of a linkage assembly (e.g., linkage bars 15A-C via crossbar 30, pneumatic cylinder 19 and movable ram 23); and a second coupling portion 62 that is configured to attach to the adaptor plate 54. As shown, the first coupling portion 60 is formed in the tail 56 of the J-shaped structure of the support bracket 52, whereas the second coupling portion 62 is formed in the stem 58 of the J-shaped structure. Each coupling portion 60, 62 of FIGS. 6A and 6B includes one or more holes, each of which is configured to receive a mechanical fastener or other means of attachment. By way of explanation, and not limitation, the first coupling portion 60 is a first embossed platform with a hole that receives therethrough a threaded stem 44 (FIG. 4) that projects from the top of the housing 23 of the pneumatic cylinder 19. Torqueing a nut 46 down onto the threaded stem 44 completes the (flexible) mechanical connection between the housing 23 and the first coupling portion 60 of the support bracket 52. The second coupling portion 62, in contrast, includes a second embossed platform 62A that protrudes from a central region of the stem 58, and a pair of legs 62B and 62C that project from the bottom of the stem 58. The platform 62A and legs 62B, 62C each has a respective hole configured to receive therethrough a bolt 64. Each bolt 64 mates with a corresponding nut 65 to thereby rigidly attach the support bracket 52 to the adaptor plate 54.

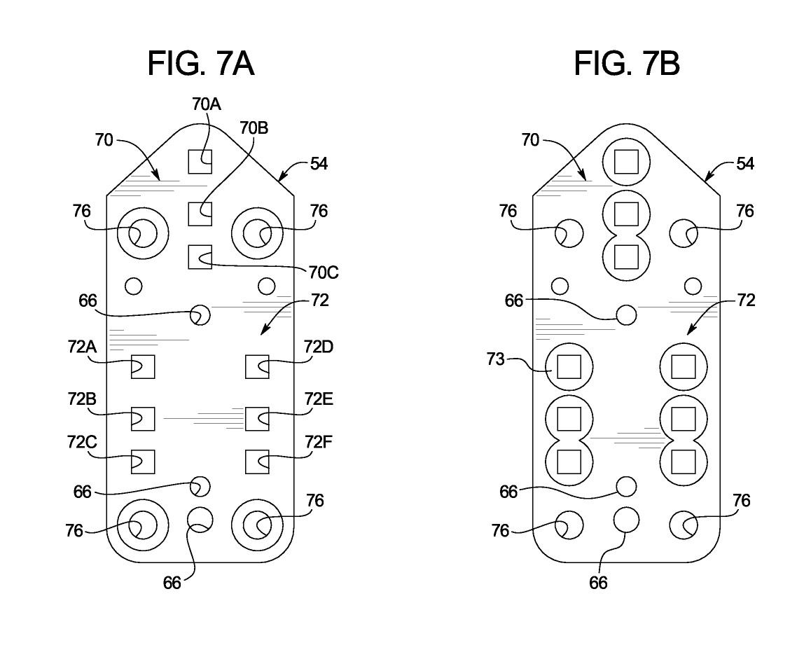

Like the support bracket 52, the adaptor plate 54 illustrated in FIGS. 6A and 6B is a single-piece unitary structure. For some preferred embodiments, the adaptor plate 54 is a flat or substantially flat metal plate that is fabricated, for example, from aluminum or steel sheet stock. The adaptor plate 54 may optionally be fabricated from a rigid plastic, such as polyvinyl chloride (PVC), polypropylene, etc., having sufficient strength and resilience for the intended application of the adaptor assembly 50. For some optional configurations, the support bracket 52 may be a multi-part component. As seen in FIGS. 7A and 7B, the adaptor plate 54 is generally rectangular with two rounded bottom corners and a triangular projection with a rounded edge extending from the top of the plate 54.

The adaptor plate 54 is configured to rigidly attach to a linkage assembly of a row unit, such as the front frame 14 of the four-bar linkage assembly 15 in FIG. 1, for example. As shown, the adaptor plate 54 includes a number of slots 66 that are spaced from one another along the longitudinal length of the plate. Each slot 66 is sized to receive therethrough a bolt 68 or other mechanical fastener to thereby rigidly mount the adaptor plate 54 to the front frame 14.

In addition to the means for attaching the adaptor plate 54 to the linkage assembly, the adaptor plate 54 also has a plurality of attachment interface points configured to couple with the support bracket 52. By way of example, a first array of attachment interface points, designated generally at 70 in FIGS. 7A and 7B, is aligned along an upper portion of the support bracket 52. As shown, the first array of attachment interface points 70 includes a first set of three (3) linearly aligned slots 70A-C that are machined into or otherwise formed in the plate 54. A second array of attachment interface points, designated generally at 72 in FIGS. 7A and 7B, is located on a lower portion of the support bracket 52, spaced apart from the first array of attachment interface points 70 along the longitudinal length of the adaptor plate 54. As shown, the second array of attachment interface points 72 includes second and third sets of three (3) linearly aligned slots 72A-C and 72D-F, respectively, that are machined into or otherwise formed in the plate 54. The first set of slots 70A-C is aligned along the central longitudinal axis of the adaptor plate 54, parallel to the second and third sets of slots 72A-C and 72D-F, which are aligned in parallel relation to each other. Each of the slots 70A-C, 72A-C and 72D-F can include a recessed portion 73 such that the head of the bolt 64 received in that slot lies flush with or below the rear face of the adaptor plate 54.

Coupling the support bracket 52 to a first subset of the attachment interface points of the adaptor plate 54 enables the linkage assembly 15 to couple a first one of the plurality of structurally distinct agricultural implements (e.g., a row unit planter manufactured by John Deere® corporation) to the towing frame 13. With reference again to FIGS. 6A and 6B, a bolt 64 is passed through the third slot 70C of the first set of slots 70A-C, and then through the hole in the embossed platform 62A of the support bracket 52, and secured in place via a nut (not visible in the views provided). In a similar regard, a bolt 64 is also passed through the third slot 72C of the second set of slots 72A-C, and then through the hole in the first leg 62B of the support bracket 52, and secured in place via a nut (not visible in the views provided) Likewise, a bolt 64 is also passed through the third slot 72F of the third set of slots 72A-C, and through the second leg 62C of the support bracket 52, and secured in place via a nut (not visible in the views provided). In so doing, the adaptor plate 54 is rigidly attached to the support bracket 52 such that a first of the agricultural implements can be operatively attached to the towing frame 13.

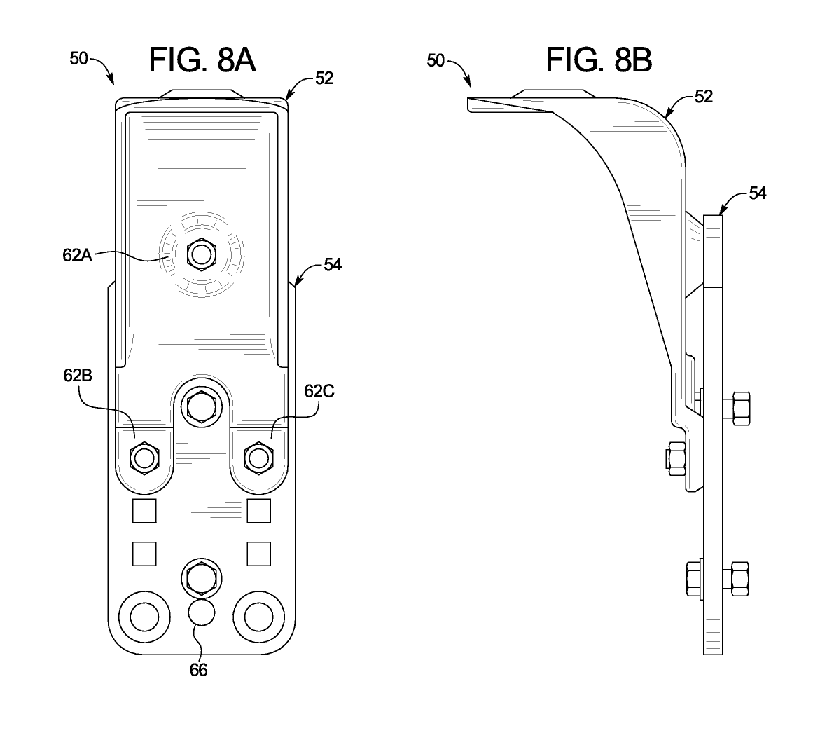

Coupling the support bracket 52 to a second subset of the attachment interface points of the adaptor plate 54 enables the linkage assembly 15 to couple a second one of the plurality of structurally distinct agricultural implements (e.g., a row unit planter manufactured by Case New Holand—CNH™) to the towing frame 13. Turning to FIGS. 8A and 8B, a bolt 64 is passed through the first slot 70A of the first set of slots 70A-C, and then through the hole in the embossed platform 62A of the support bracket 52, and secured in place via a nut (not visible in the views provided). Moreover, a bolt 64 is also passed through the first slot 72A of the second set of slots 72A-C, and then through the hole in the first leg 62B of the support bracket 52, and secured in place via a nut (not visible). Similarly, a bolt 64 is also passed through the first slot 72D of the third set of slots 72A-C, and through the second leg 62C of the support bracket 52, and secured in place via a nut (not visible). Rigidly attaching the adaptor plate 54 to the support bracket 52 in the manner shown in FIGS. 8A and 8B allows a second of the agricultural implements to be operatively attached to the towing frame 13. Attaching a second one of the structurally distinct agricultural implements to the towing frame 13 may also necessitate a bolt 68 be passed through a different one of the slots 66 in the adaptor plate, as can be seen when comparing the arrangement shown in FIGS. 8A and 8B with the arrangement shown in FIGS. 6A and 6B.

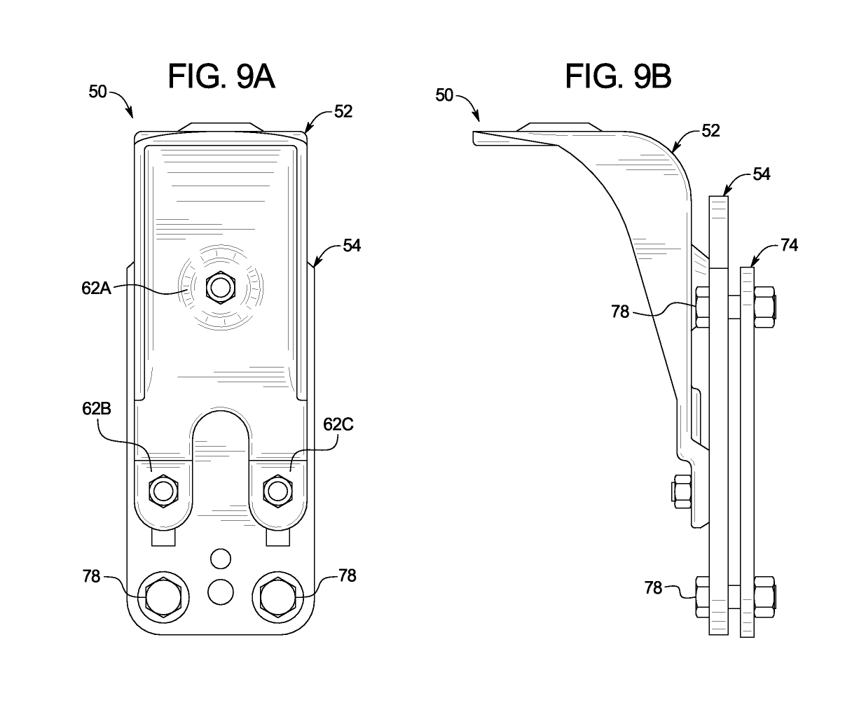

The universal bracket adaptor assembly 50 may also include an optional backing plate 74 that is configured to rigidly attach to the adaptor plate 54. As shown, the adaptor plate 54 includes four additional bolt slots 76 that are spaced from one another on the plate 54. Each slot 76 is sized to receive therethrough a bolt 78 or other mechanical fastener that is first passed through a complementary slot in the backing plate 74 to thereby rigidly mount the adaptor plate 54 to the backing plate 74. The optional backing plate 74 of FIGS. 9A and 9B provides additional structural support for attaching an agricultural implement to a towing frame.

Attaching the backing plate 74 to the adaptor plate 54, and coupling the support bracket 52 to a third subset of the attachment interface points of the adaptor plate 54 enables the linkage assembly to couple a third one of the plurality of agricultural implements (e.g., a row unit planter manufactured by Kinze Manufacturing, Inc.) to the towing frame 13. Turning to FIGS. 9A and 9B, a bolt 64 is passed through the second slot 70B of the first set of slots 70A-C, and then through the hole in the embossed platform 62A of the support bracket 52, and secured in place via a nut (not visible in the views provided). In a similar regard, a bolt 64 is also passed through the second slot 72B of the second set of slots 72A-C, and then through the hole in the first leg 62B of the support bracket 52, and secured in place via a nut (not visible) Likewise, a bolt 64 is also passed through the second slot 72E of the third set of slots 72A-C, and through the second leg 62C of the support bracket 52, and secured in place via a nut (not visible). In so doing, the adaptor plate 54 is rigidly attached to the support bracket 52 such that a third of the agricultural implements can be operatively attached to the towing frame 13.

While many embodiments and modes for carrying out the present invention have been described in detail above, those familiar with the art to which this invention relates will recognize various alternative designs and embodiments for practicing the invention within the scope of the appended claims.

What is claimed is:

1. An adaptor assembly for enabling a linkage assembly to couple any of a plurality of agricultural implements to a towing frame, the linkage assembly having a linkage bar attached to a front bracket coupled to the towing frame, each of the agricultural implements being at least partially structurally distinct from one another, the adaptor assembly comprising:
a support bracket with first and second coupling portions, the first coupling portion being configured to attach to the linkage bar; and
an adaptor plate configured to attach to the front bracket, the adaptor plate having a plurality of attachment interface points configured to couple with the second coupling portion of the support bracket,
wherein coupling the support bracket to a first subset of the attachment interface points of the adaptor plate enables the linkage assembly to couple a first one of the plurality of agricultural implements to the towing frame, and
wherein coupling the support bracket to a second subset of the attachment interface points of the adaptor plate enables the linkage assembly to couple a second one of the plurality of agricultural implements to the towing frame.

2. The adaptor assembly of claim 1, wherein the plurality of attachment interface points includes an array of slots.

3. The adaptor assembly of claim 2, wherein each of the slots is configured to receive therethrough a bolt whereby the support bracket is coupled to the adaptor plate.

4. The adaptor assembly of claim 1, further comprising a backing plate configured to attach to the adaptor plate, wherein attaching the backing plate to the adaptor plate and coupling the support bracket to a third subset of the attachment interface points of the adaptor plate enables the linkage assembly to couple a third one of the plurality of agricultural implements to the towing frame.

5. The adaptor assembly of claim 1, wherein each of the subsets of the attachment interface points comprises two or more of the plurality of attachment interface points.

6. The adaptor assembly of claim 1, wherein the adaptor plate is a single-piece unitary structure.

7. The adaptor assembly of claim 6, wherein the adaptor plate is fabricated from a piece of sheet metal with the attachment interface points machined into the piece of sheet metal.

8. The adaptor assembly of claim 1, wherein the support bracket is a single-piece unitary structure.

9. The adaptor assembly of claim 8, wherein the support bracket is a J-shaped structure, the first coupling portion being formed in the tail of the J-shaped structure and the second coupling portion being formed in the stem of the J-shaped structure.

10. The adaptor assembly of claim 1, wherein each of the coupling portions of the support bracket includes one or more holes, each of the holes being configured to receive therethrough a bolt whereby the support bracket is coupled to the adaptor plate.

11. A pressure control unit for attaching any of a plurality of agricultural implements to a towing frame, each of the agricultural implements being at least partially structurally distinct from one another, the pressure control unit comprising:
a front bracket adapted to rigidly attach to the towing frame;
a linkage bar pivotably attached to the front bracket, the linkage bar being adapted to pivotably mount to any of the plurality of agricultural implements;
a pressurized-fluid cylinder with a movable ram extending out of the pressurized-fluid cylinder and operatively coupled to the linkage bar, the pressurized-fluid cylinder forming therein a fluid cavity configured to receive pressurized fluid for moving the ram and thereby pivoting the linkage;
an energy storage device operatively coupled to the pressurized-fluid cylinder and defining therein a fluid chamber containing a diaphragm;
a support bracket with first and second coupling portions, the first coupling portion being attached to the linkage bar via the pressurized-fluid cylinder and the movable ram; and
an adaptor plate attached to the front bracket, the adaptor plate having a plurality of attachment interface points configured to couple with the second coupling portion of the support bracket and thereby attach the adaptor plate to the support bracket,
wherein coupling the support bracket to a first subset of the attachment interface points of the adaptor plate enables the linkage assembly to couple a first one of the plurality of agricultural implements to the towing frame, and
wherein coupling the support bracket to a second subset of the attachment interface points of the adaptor plate enables the linkage assembly to couple a second one of the plurality of agricultural implements to the towing frame.

12. The pressure control unit of claim 11, wherein the plurality of attachment interface points includes an array of slots, wherein each of the slots is configured to receive a bolt whereby the support bracket is coupled to the adaptor plate.

13. The pressure control unit of claim 11, further comprising a backing plate configured to attach to the adaptor plate, wherein attaching the backing plate to the adaptor plate and coupling the support bracket to a third subset of the attachment interface points of the adaptor plate enables the linkage assembly to couple a third one of the plurality of agricultural implements to the towing frame.

14. The pressure control unit of claim 11, wherein each of the subsets of the attachment interface points comprises two or more of the plurality of attachment interface points.

15. The pressure control unit of claim 11, wherein the adaptor plate is a single-piece unitary structure, the adaptor plate being fabricated from a metal plate with the attachment interface points being machined or formed into the metal plate.

16. The pressure control unit of claim 11, wherein the support bracket is a single-piece unitary structure, the support bracket being a J-shaped structure, the first coupling portion being formed in the tail of the J-shaped structure and the second coupling portion being formed in the stem of the J-shaped structure.

17. The pressure control unit of claim 11, wherein the pressurized-fluid cylinder is formed from a single-piece unitary housing having a cavity containing at least a portion of the energy storage device.

18. The pressure control unit of claim 11, wherein the linkage bar includes a plurality of linkage bars pivotably attached to the front bracket and interconnected via a cross bar coupled to the pressurized-fluid cylinder via the movable ram.

19. The pressure control unit of claim 11, further comprising a hose configured to fluidly couple the fluid cavity of the pressurized-fluid cylinder to a source of pressurized fluid.

20. A universal bracket adaptor assembly for assisting in coupling any of an assortment of structurally distinct agricultural implements to a towing frame of an agricultural machine, the adaptor assembly comprising:
a support bracket with first and second coupling portions, the first coupling portion being configured to operatively attach to any of the agricultural implements; and
an adaptor plate configured to operatively attach to the towing frame, the adaptor plate having a plurality of attachment interface points configured to couple with the second coupling portion of the support bracket,
wherein coupling the support bracket to a first subset of the attachment interface points of the adaptor plate assists in coupling a first one of the agricultural implements to the towing frame, and
wherein coupling the support bracket to a second subset of the attachment interfaces of the adaptor plate assists in coupling a second one of the agricultural implements to the towing frame.
